(19) United States
(12) Patent Application Publication
(10) Pub. No.: US 2023/0014451 A1
(43) Pub. Date: Jan. 19, 2023

(54) HERB ROLLING TRAY AUTOMOBILE ACCESSORY

(71) Applicant: Lauran Offutt, McCordsville, IN (US)

(72) Inventor: Lauran Offutt, McCordsville, IN (US)

(21) Appl. No.: 17/567,998

(22) Filed: Jan. 4, 2022

Related U.S. Application Data
(60) Provisional application No. 63/222,509, filed on Jul. 16, 2021.

(51) Int. Cl. B60N 3/00

(52) U.S. Cl. CPC B60N 3/002

(57) ABSTRACT

The present disclosure is directed to a tray having a flat tray interior working surface from which a vertical or nearly vertical endless sidewall extends. A substantially flat tray bottom surface opposes the interior working surface. The tray also includes at least one mounting component having a first end extending from the tray and a second end including an attachment configured for removably attaching the tray to an interior component of a vehicle.

### CROSS-REFERENCE TO RELATED APPLICATIONS

The present application claims the benefit of U.S. Provisional Patent Application 63/222,509 filed Jul. 16, 2021, under 35 USC §119(e).

### BACKGROUND

Hand-rolling herbs for smoking, including the rolling of cigarettes, cigars, and the like, is increasing in popularity. By hand-rolling herbs, the smoker is able to customize the cigarette or other to one's own preference. For example, the smoker has control over which herb is used and the size, length, density, and the like of the rolled herb, and preferences regarding the rolling paper or other means for supporting and smoking the herbs. As such, many smokers prefer hand-rolling over purchasing mass produced cigarettes, cigars, etc.

As an example, and with respect to cigarettes, to roll a cigarette, tobacco is typically sorted in an herb rolling tray positioned on a surface, and then measured onto a sheet of cigarette paper, and the paper rolled into a cigarette.

There is a growing need to accommodate smokers rolling cigarettes or the like in different environments and/or locations, including in vehicles and other means of transportation when traveling, and including many other circumstances. There remains a need for a rolling tray for use by different users in different environments for producing on-demand cigarettes.

The present novel technology addresses this need.

### SUMMARY

The disclosure is directed to an herb rolling tray automobile accessory comprising a tray. The tray, or rolling tray, includes a flat interior working surface from which a vertical or nearly vertical endless sidewall extends. The tray also includes a substantially flat tray bottom surface opposing the interior working surface and at least one mounting component having a first end extending from the tray and a second end including an attachment configured for removably attaching the tray to an interior component of a vehicle. The construction and configuration of the tray, and the mounting component, may vary, with regard to size, weight, material, etc., depending on the particular application. In addition, it should be appreciated that the present disclosure has a broader applicability than what is presented herein as an exemplary embodiment.

### BRIEF DESCRIPTION OF THE DRAWINGS

FIG. 1 depicts a top perspective view of an exemplary embodiment of an herb rolling tray, according to the present disclosure;

FIG. 2 provides a bottom view of the mounting component and of the substantially flat bottom surface of the herb rolling tray.

FIG. 3 shows another top perspective view of the herb rolling, tray.

FIG. 4 shows a top view of the herb rolling tray.

### DETAILED DESCRIPTION

Before the present methods, implementations, and systems are disclosed and described, it is to be understood that this invention is not limited to specific implementations, and as such may, of course, vary. It is also to be understood that the terminology used herein is for the purpose of describing particular implementations only and is not intended to be limiting.

For the purposes of promoting an understanding of the principles of the invention and presenting its currently understood best mode of operation, reference will now be made to the embodiments illustrated in the drawings and specific language will be used to describe the same. It will nevertheless be understood that no limitation of the scope of the invention is thereby intended, with such alterations and further modifications in the illustrated device and such further applications of the principles of the invention as illustrated therein being contemplated as would normally occur to one skilled in the art to which the invention relates.

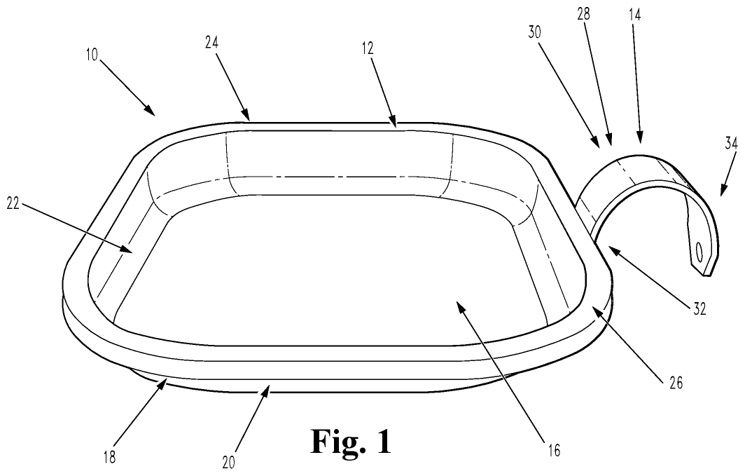

As shown in FIG. 1, the exemplary embodiment of the rolling tray 10 for herbs for smoking includes a tray 12 and an attachment 14. The tray 12 includes a flat tray interior working surface 16 for sorting and rolling herbs. A vertical endless sidewall 18 extends around a perimeter of the tray 12.

According to the exemplary embodiment, the tray 12 includes four sides 20, 22, 24, and 26 defining the perimeter of the tray 12. The shape, configuration, and height of the four sides 20, 22, 24, and 26 may vary depending on the application. The function of the sides 20, 22, 24, and 26 may include restricting objects, including herbs, from sliding off the tray 12 and/or separating the herbs from the environment exterior to the tray 12.

The tray 12 includes at least one mounting component 28, shown here as a relatively wide hook 30, which is configured to support the tray 12 on a component of the interior of the vehicle (not shown). The hook 30 has at least one mounting component 28 having a first end 32 secured to and extending from the tray 12 and a second end 34 including an attachment feature 36 configured for removably attaching the tray 12 to an interior component of a vehicle.

Although a variety of different materials may be used, the use of metal will be discussed herein. The first end 32 may be attached to the tray 12 using any of a variety of different attachment means. For example, the first end may be attached to the tray using welding, gluing, soldering, brazing, riveting, and bolting, etc.

As shown, the second end 34 has an attachment feature embodied as a hook 30. The hook 30 may be shaped and sized such that it may be secured to one or more interior components of a vehicle. The tray 12 may be attached to, or supported by, one of various components of the interior of the vehicle including, for example, a door handle or a cup holder. The configuration of the hook 30 may vary to accommodate the desired components.

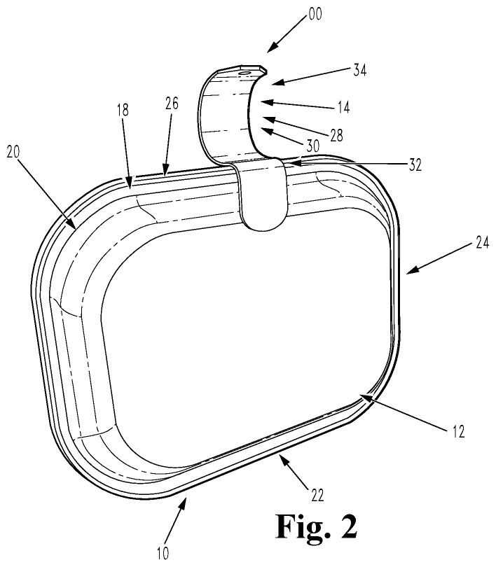

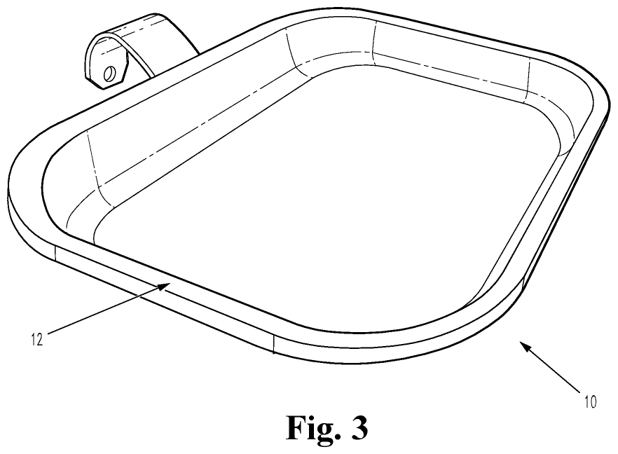

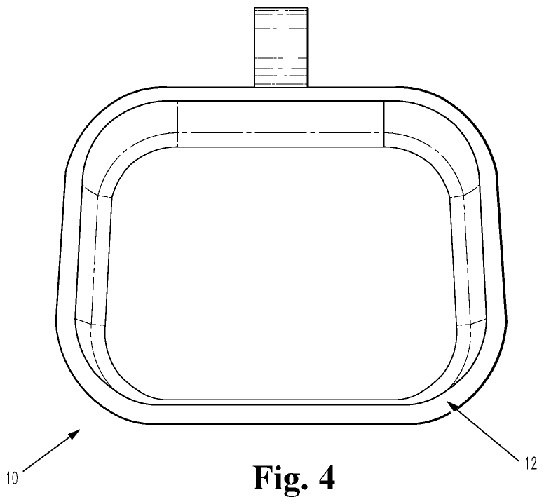

FIG. 2 provides a bottom view of the mounting component and of a substantially flat bottom surface 38 of the tray 12. FIG. 3 shows another top perspective view of the rolling tray 12. FIG. 4 shows a top view of the rolling tray 12.

As described, the herb roiling tray 12 may be customizable depending on the application. The smoker may be confident that, when in different environments, such as in a moving vehicle, the herb rolling tray 12 and attachment will remain sufficiently stationary relative to the moving vehicle.

I/we claim:

1. An herb rolling tray configured as an automobile accessory for rolling and containing smokable herbs, comprising:
a tray, comprising:
a substantially planar flat tray interior working surface from which a vertical endless sidewall extends;
a substantially flat tray bottom surface opposing the interior working surface; and
at least one mounting component having a first end secured to and extending from the tray and a second end including an attachment configured for removably attaching the tray to an interior component of a vehicle.

2. The herb rolling tray of claim 1, wherein the mounting component includes one or more hooks extending from the tray and terminating in a hook portion that attaches to the interior component of a vehicle.

3. The herb rolling tray of claim 3, wherein the one or more hooks are integral with the tray.

4. The herb rolling tray of claim 2, wherein the one or more hooks are welded to the tray.

5. The herb rolling tray of claim 1, wherein the mounting component includes at least one clamp.

6. The herb rolling tray of claim 1, wherein the interior component of the vehicle includes a door handle or a cup holder.

7. The herb rolling tray of claim 1, wherein the mounting component includes a spring-like characteristic for minimizing vibrations between the tray and the vehicle.

8. The herb rolling tray of claim 1, wherein the mounting component and the tray move together.
